(19) United States
(12) Patent Application Publication
(10) Pub. No.: US 2008/0137870 A1
(43) Pub. Date: Jun. 12, 2008

(54) Method And Device For Individualizing Hrtfs By Modeling

(75) Inventors: Rozenn Nicol, La Roche Derrien (FR); Sylvain Busson, Rennes (FR); Vincent Lemaire, Trebeurden (FR)

Correspondence Address: MCKENNA LONG & ALDRIDGE LLP, 1900 K STREET, NW, WASHINGTON, DC, 20006, US

(73) Assignee: FRANCE TELECOM, Paris (FR)

(21) Appl. No.: 11/794,987

(22) PCT Filed: Jan. 9, 2006
(86) PCT No.: PCT/FR2006/000037

§ 371 Date: Jul. 10, 2007

(30) Foreign Application Priority Data
Jan. 10, 2005 (FR) 0500218

(51) Int. Cl. H04R 5/00

(52) U.S. Cl. 381/17

(57) ABSTRACT

Disclosed is a system and method for method of modeling head-related transfer functions HRTFs specific to an individual. The method includes constructing a database of a plurality of HRTFs for a multitude of directions and for a plurality of individuals, and using an artificial neural network to construct a model from the database. The method further comprises measuring an HRTF for a given individual for a few selected directions, applying the model to the measurements, and calculating the individual's HRTF in the multitude of directions based on the application of the model.

The present invention relates to the modeling of individual head-related transfer functions HRTFS, with respect to the hearing of an individual in a three-dimensional space.

The invention is particularly applicable in the context of telecommunication services offering a spatialized sound broadcast (for example, an audio conference between multiple listeners, a cinema trailer broadcast). On telecommunication terminals, in particular mobile terminals, sound rendition with a stereophonic headset is envisaged. The most effective technique for positioning sound sources in space is then binaural synthesis.

Binaural synthesis is based on the use of filters, called “binaural” filters, which reproduce the acoustic transfer functions between the sound source and the ears of the listener. These filters serve to simulate auditory locating indices, indices that enable a listener to locate the sound sources in a real hearing situation. These filters take account of the set of acoustic phenomena (in particular, diffraction by the head, reflections on the auricle and the top of the torso) which modify the acoustic wave in its path between the source and the ears of the listener. These phenomena vary strongly with the position of the sound source (mainly with its direction) and these variations enable the listener to locate the source in space. In practice, these variations determine a kind of acoustic encoding of the position of the source. An individual's auditory system knows, through learning, how to interpret this encoding to locate the sound sources. Nevertheless, the acoustic diffraction/reverberation phenomena all also strongly depend on the morphology of the individual. A quality binaural synthesis therefore relies on binaural filters which best reproduce the acoustic encoding that the body of the listener naturally produces, by taking account of the individual specifics of his morphology. When these conditions are not respected, a degradation of the binaural rendition performance levels is observed, which is reflected in particular in an intracranial perception of the sources and front/rear confusions. The sources located at the front are perceived at the back and vice versa.

Among the 3D sound, or sound spatialization, technologies, in processing the audio signal applied in particular to the simulation of acoustic and psycho-acoustic phenomena, some aim for the generation of signals to be broadcast to loudspeakers or to earphones, in order to give the listener the auditory illusion of sound sources placed in particular respective positions around him. The notion of the creation of virtual sound sources and images then arises.

The binaural techniques described above are applied to the processing of a 3D sound intended for broadcast to headphones with two earpieces, left and right. These techniques aim to reconstruct the sound field at the ears of a listener, so that the eardrums perceive a sound field that is practically identical to that which would have been induced by the real sources in the 3D space. The binaural techniques are therefore based on a pair of binaural signals which respectively feed the two earpieces of the headset. These binaural signals can be obtained in two ways:
by direct sound pick-up, by means of two microphones inserted at the input of the auditory canal of an individual or of a model with standard morphology (“artificial head”), or
by processing the signal, by filtering a monophonic signal through two binaural filters, these filters reproducing the properties of the acoustic propagation between the source placed in a given position and the two ears of a listener.

The binaural techniques that use binaural filters define the binaural synthesis domain in an advantageous context of the present invention. Binaural synthesis relies on the binaural filters which model the propagation of the acoustic wave between the source and the two ears of the listener. These filters represent acoustic transfer functions called HRTFs, which model the transformations caused by the torso, the head and the auricle of the listener on the signal originating from a sound source. Each sound source position has an associated pair of HRTFs (one HRTF for the right ear, one HRTF for the left ear). Moreover, the HRTFs carry the acoustic imprint of the morphology of the individual on whom they have been measured.

The HRTFs therefore depend not only on the direction of the sound, but also on the individual. They are thus a function of the frequency f, the position (θ, Φ) of the sound source (where the angle θ represents the azimuth and the angle Φ represents the elevation), and the ear (left or right) of the individual.

Conventionally, the HRTFs are obtained by measurement. Initially, a selection of directions is fixed which more or less finely cover all the space surrounding the listener. For each direction, the left and right HRTFs are measured by means of microphones inserted at the input of the auditory canal of a subject. The measurement must be performed in an anechoic room (or “dead room”). Ultimately, if M directions are measured, a database of 2M acoustic transfer functions is obtained, for a given subject, representing each position of the space for each ear.

In the advantageous context of binaural synthesis, the spatialization effect relies on the use of HRTFs which, for optimum performance, must take account of the acoustic propagation phenomena between the source and the ears, but also the individual specifics of the morphology of the listener. Experimental measurement of the HRTFs directly on an individual is, currently, the most reliable solution for obtaining quality and truly individualized binaural filters (taking account of the individual specifics of the morphology of the individual). It will be remembered that it is a question of measuring the transfer function between a source located in a given position (θ1, Φ1) and the two ears of the subject by means of microphones placed at the input of the auditory canals of that person.

However, measuring these transfer functions HRTFs does present a few difficulties. It requires dedicated and expensive equipment (typically, a dead room, a microphone, a mechanical source positioning device). This operation is lengthy because it entails in particular measuring the transfer functions for a large number of directions in order to uniformly cover the whole of a 3D sphere surrounding the listener.

This measurement of the HRTFs becomes very difficult, even impossible, in the context of binaural synthesis applications intended for the general public. The measurement of the HRTFs in fact raises at least three main problems:
measuring the HRTFs in itself is difficult to implement, because it requires dedicated equipment. The measurement must be carried out in an anechoic room. It also requires a mechanical device for moving and controlling the measurement loudspeaker in order to perform measurements for a large number of directions uniformly distributed in azimuth and in elevation around the listener. Also, the measurement procedure as a whole is uncomfortable for the subject, because of the constraints imposed on the subject by the measurement system and because of the measurement time involved.
A second problem lies in the need to measure the HRTFS in a large number of directions to offer an adequate and uniform spatial sampling of the 3D sphere surrounding the listener. The greater the number of directions that are measured, the longer the test takes, which increases the discomfort of the subject.
A third problem concerns the measuring of an individual in particular. To offer a powerful binaural synthesis to any individual presupposes the use of his own HRTFs, which will need to have been measured beforehand, which is normally not possible.

Solutions have therefore been sought that require a minimum of HRTF measurements and implement more modeling techniques. In particular, mathematical models of HRTFs have been sought that consist of a function F for expressing an HRTF (Y) based on an a priori given set of parameters (X), such that Y=F(X). Often, two key elements are involved:
the development of the mathematical model (function F), and
the specification of the set of parameters to be applied as input for the model.

There follows a description of the state of the art as known to the inventors concerning the HRTF modeling currently implemented, paying particular attention to the choice of model input parameters.

In the document US-2003/138107, a statistical model of HRTFS based on morphological data is described. This approach starts from a statistical analysis applied to a database including HRTFs and morphological data. A main component analysis is first applied on the one hand to the HRTFS and on the other hand to the morphological data, which makes it possible to describe all the data with a small number of components. Then, a linear regression is performed between the components derived from the main component analysis of the HRTFS and the components derived from that of the morphological data. A statistical model is thus created that links the morphological data to the HRTFS. All that is then needed is to measure the morphological parameters of any individual to predict his HRTFS based on the statistical model obtained.

One embodiment in this document provides in particular for complementing the morphological data of an individual, at the model input stage, with a few HRTFs measured on that individual, and in specific respective directions. Thus, only a small number of measurement directions is useful to obtain the HRTFs of the individual in all the directions in space.

Nevertheless, even though the number of measurements is small in this document, it is still necessary to observe the HRTF measurement protocol, in particular to provide an anechoic room for the measurements and strictly position the sources at very precise distances from the microphones which are attached to the ears of the individual.

The implementation of the present invention does away with such constraints.

The present invention to this end aims for a method of modeling head-related transfer functions HRTFs specific to an individual, in which:
a) a database is constructed including a plurality of HRTFs in a multiplicity of directions in space and for a plurality of individuals,
b) by learning from said database, a specific model is constructed to give HRTFS for said multiplicity of directions, based on a series of measurements representative of HRTFs in respective directions selected from said multiplicity of directions, and
c) for any individual:
   c1)a series of functions representative of the HRTFs of the individual only in said selected directions is measured,
   c2)the model is applied to said measurements in the selected directions, and
   c3)the HRTFs of the individual are obtained in all said multiplicity of directions.

Also, in the method according to the invention:
the measurement conditions and directions to obtain said series of measurements are arbitrarily fixed during the learning step b), and
measurement conditions roughly reproducible with the measurement conditions of the step b) are applied in the step c).

Thus, according to one aspect of the invention, it is possible to arbitrarily fix, from the learning step, the conditions and the directions in which the functions representative of the HRTFs will be measured. The term “arbitrarily” should be understood to convey the fact that these measurements are not necessarily preferred directions for the model to give better results. It will therefore be understood that these measurement conditions and/or directions can be chosen for reasons that are independent of the operation of the model. Moreover, the measurement conditions are not necessarily optimal. This is why the expression “measurements representative of HRTFs” is used instead of “measurements of HRTFS”.

However, the measurement conditions of the step c1), on any individual, should preferably be reproducible with those used to construct the model in the step b). Thus, these measurement conditions can be chosen according to criteria that are totally independent of the operation of the model, the main consideration being that they are reproducible between the moment when the model is constructed, in the step b), and the moment when the measurements are conducted on any individual, in the step c).

Thus, according to one of the advantages provided by the present invention, complete HRTFs of any individuals can be obtained by roughly measuring his HRTFS only in a few directions, with a less onerous measurement procedure (that is, involving only a small number of measurement directions and/or a simplified measuring device).

In a preferred embodiment, the model is constructed by setting up an artificial neural network. This category of powerful mathematical models is capable of identifying and reproducing high-level dependencies between the input and output variables, without being limited to trivial solutions. It is then possible to apply as input for the model parameters whose relationship with the HRTFs is not necessarily obvious, but based on which the model will nevertheless be able to extract information making it possible to calculate the complete HRTFs of any individual.

The present invention also aims for an installation for implementing the above method and, more particularly, for estimating head-related transfer functions HRTFS specific to an individual. This installation comprises:
a booth for measuring transfer functions representative of HRTFs in a set of chosen directions, and
a processing unit for recovering a series of measurements on an individual in said chosen directions and evaluating the HRTFs of the individual in a multiplicity of directions in space including said chosen directions, based on a model capable of giving HRTFs for a multiplicity of directions, based on a series of measurements representative of HRTFs only in a few arbitrarily fixed directions of said multiplicity of directions.

According to the invention, the measurement directions in the abovementioned booth then correspond to said arbitrarily fixed directions, to respect the measurement conditions between the learning step of the model and its subsequent use.

The present invention also aims for a computer program product to construct the model. This program can be stored in a memory of a processing unit or on a removable medium specifically for cooperating with a drive of that processing unit, or even be transmitted from a server to the processing unit, in particular via a wide-area network. The program then comprises instructions in computer code form to construct a model capable of giving transfer functions HRTFs of an individual for a multiplicity of directions, based on a series of measurements, performed on that individual, representative of HRTFS, only in a few arbitrarily fixed directions of said multiplicity of directions, the program using a database including a plurality of HRTFs in a multiplicity of directions in space and for a plurality of individuals to implement at least one learning phase.

The present invention also aims for a second computer program product, designed to be stored in a memory of a processing unit or on a removable medium specifically for cooperating with a drive of said processing unit, or intended to be transmitted from a server to said processing unit. As for this second program, it comprises instructions in computer code form for implementing a model based on an artificial neural network and capable of giving transfer functions HRTFs of an individual for a multiplicity of directions, based on a series of measurements performed on that individual, representative of HRTFS, only in a few arbitrarily fixed directions of said multiplicity of directions.

Thus, the first program described above makes it possible to construct the model, whereas the second program consists of computer instructions representing the model itself.

Other characteristics and advantages of the invention will become apparent from studying the detailed description below, and the appended drawings in which:

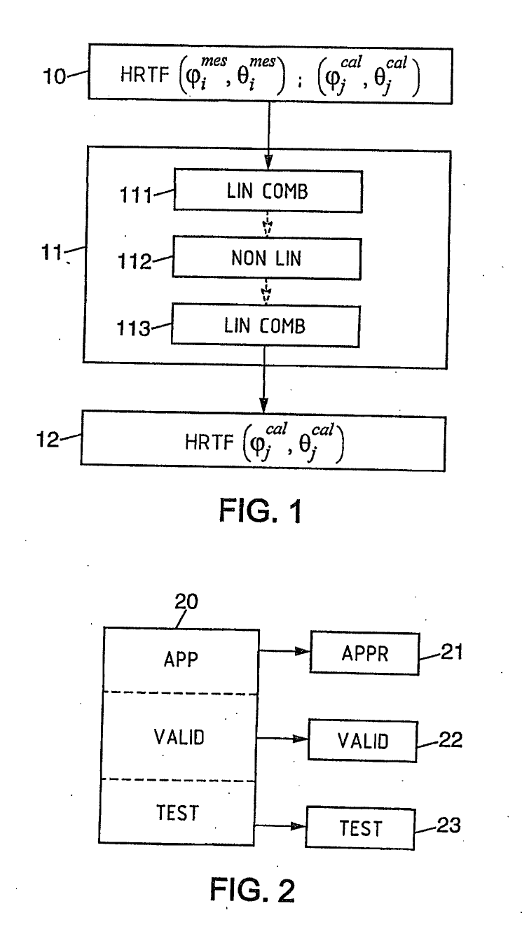

FIG. 1 diagrammatically illustrates the operational steps of a model implementing an artificial neural network, which can then correspond to a flow diagram diagrammatically representing the progress of the second computer program described above,

FIG. 2 diagrammatically illustrates the steps in constructing the model, which can then correspond to a flow diagram diagrammatically representing the progress of the first computer program described above,

FIG. 3 represents the variation of a validation error in the step for constructing the model according to the total number of measurements to be made to use the model,

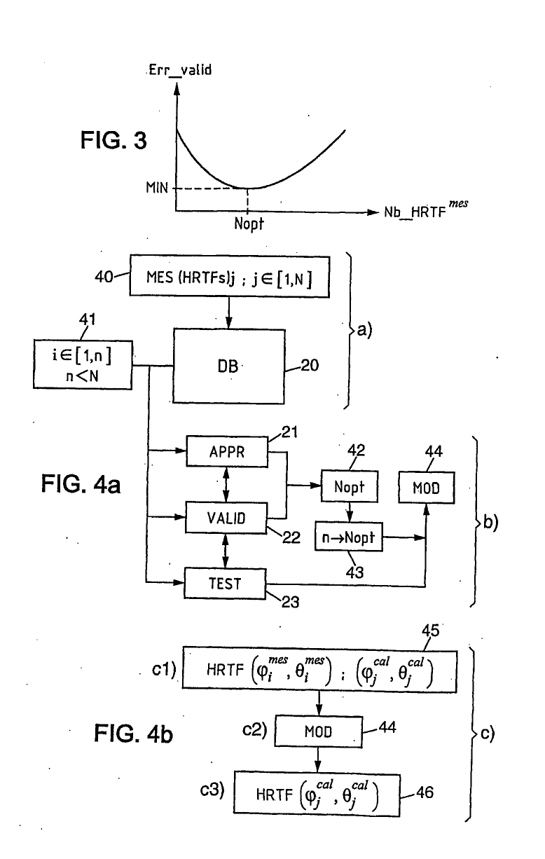

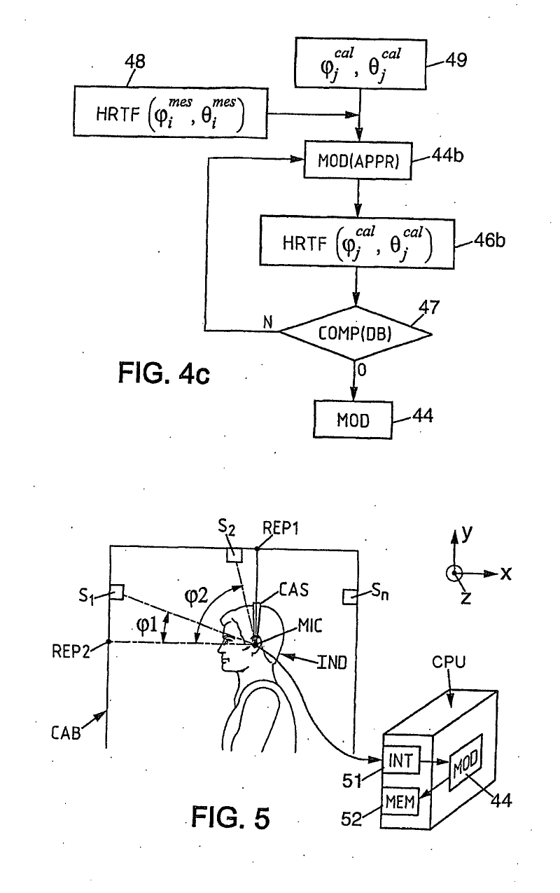

FIG. 4a diagrammatically illustrates the steps a) and b) of the method according to the invention,

FIG. 4b diagrammatically illustrates the step c) of the method according to the invention,

FIG. 4c diagrammatically illustrates one advantageous embodiment for the construction of the model in the steps a) and b) of the method according to the invention, and

FIG. 5 diagrammatically represents an installation for implementing the invention.

It will be recalled that the present invention proposes to calculate the transfer functions by means of a mathematical model based on a function F which can be used to express a transfer function based on a number of input parameters. More specifically, if the transfer function sought is represented in the form of a vector Y (Y ε [symbol] ⁿ, n ε [symbol] ) and if the input parameters are described in the form of a vector X (X ε [symbol] ^{m}, m ε [symbol] ), the function F defines the following relationship: Y=F(X). In other words, the function F can be used to deduce a transfer function of a given set of a priori known parameters. The interest of the mathematical model lies in the use of input parameters that can easily be acquired for any individual, while still bearing in mind that their relationship with the transfer function is not necessarily direct or obvious. The mathematical model must in particular be capable of extracting the information that is more or less hidden in the input parameters in order to deduce from it the transfer function sought. The inventive method essentially relies on two points:
the definition of the function F,
the determination of the input parameters X.

The mathematical model of the HRTFs relies on the function F that can be used to express an HRTF based on a given number of input parameters. The input parameters are combined in a vector X (X ε [symbol] ^{m}, m ε [symbol] ) which therefore constitutes the input vector of the function F. The output vector of the function is an HRTF which is represented by a vector Y (Y ε [symbol] ⁿ, n ε [symbol] ). For example, this vector Y can consist of frequency coefficients describing the modulus of the spectrum of the transfer function defined by the HRTF. Likewise, Y can consist of:
time coefficients describing the impulse response associated with the transfer function defined by the HRTF,
or frequency coefficients describing the complex spectrum of the transfer function defined by the HRTF.

The function F is therefore a function of [symbol] ^{m} in [symbol] ⁿ.

The problem of the modeling consists in determining the function F, in association with a relevant set of parameters (X), such that any HRTF (Y) is the solution of: Y=F(X).

Specifically for estimating the HRTFs of an individual, the input vector X of the model mainly contains information relating to:
the direction in which an HRTF is to be calculated, preferably in the form of an azimuth angle (θ) and an elevation angle (Φ),
and “individual” parameters (such as HRTFs measured in only a few directions in space, as will be seen later), these individual parameters being intended to add to the model information relating to the specifics of the individual for whom the HRTFs are to be calculated.

The output vector Y of the model consists of coefficients associated with a given representation of an HRTF. As indicated above, the vector Y can correspond to the frequency coefficients describing the modulus of the spectrum of an HRTF, but other representations can be considered (analysis in terms of main components, IIR filter, or others).

Here, the model is applied for interpolation purposes. A small number of HRTFs is measured on an individual. The model is then used to calculate the HRTFs of that individual in all the directions covering the 3D sphere. The HRTFs measured previously are then used as input parameters for the model. The modeling consists mainly in:
determining the function F which best approaches the relationship between X and Y,
determining the most suitable set X of input parameters, related to the function F, particularly in terms of quality and quantity of the information added by the parameters and which can be analyzed by the model used.

The determination of F and of the vector X are of course not independent.

There is a wide variety of mathematical methods for determining these two entities F and X. The inventive method is preferably based on statistical learning algorithms and, in a preferred embodiment, on algorithms of the type with artificial neural networks. These algorithms are briefly described below.

The statistical learning algorithms are statistical process prediction tools. They have been used successfully to predict processes for which several explanatory variables can be identified. The artificial neural networks define a particular category of these algorithms. The interest of the neural networks lies in their ability to pick up high-level dependencies, that is, dependencies that involve several variables at a time. The prediction of the process exploits the knowledge and the analysis of high-level dependencies. There is a wide variety of areas of application for neural networks, in particular in the financial techniques for predicting market fluctuations, in pharmaceuticals, in the banking domain for the detection of credit card fraud, in marketing for forecasting consumer behavior, and other areas. The neural networks are often considered as universal predictors, in the sense that they are capable of predicting any data from any explanatory variables, provided that the number of hidden units is sufficient. In other words, they can be used to model any mathematical function of [symbol] ^{m} in [symbol] ⁿ, if the number of hidden units m is sufficient.

With reference to FIG. 1, a neural network consists of three layers: an input layer 10, a hidden layer 11 and an output layer 12. The input layer 11 corresponds to the explanatory variables, that is, the input variables (the abovementioned vector X), from which the prediction is made, and which will be described in detail below. The output layer 12 defines the predicted values (the abovementioned vector Y).

In the hidden layer, a first step 111 consists in calculating linear combinations of the explanatory variables so as to combine the information potentially originating from several variables. The second step 112 consists in applying a non-linear transformation (for example, a function of the “hyperbolic tangent” type) to each of the linear combinations in order to obtain the values of the hidden units or neurons that constitute the hidden layer. This non-linear transformation defines the activation function of the neurons. Finally, the hidden units are recombined linearly, in the step 113, in order to calculate the value predicted by the neural network.

Initially, developing a neural network entails three operations:
learning, consisting in optimizing the parameters of the hidden layer based on a series of training examples (forming a learning set), from which the neural network seeks to minimize its prediction error;
the validation procedure, conducted in parallel with the learning and intended to optimize the number of hidden layers of the network, in order for the neural network not to overlearn the learning set. The network models only the basic dependency relationships and does not seek to reproduce the relationships that are due only to statistical fluctuations of the learning set. In addition to the learning error, a prediction error is thus evaluated on examples obtained from a validation set, which is separate from the learning set. This error defines the validation error. It begins by decreasing when the number of hidden layers is increased, reaches a minimum, then increases when the number of hidden layers becomes too great. The minimum therefore defines an optimal number of hidden layers of the network;
calculation of the final prediction error, on a third test set, separate from the preceding two sets.

There are various categories of neural networks that are distinguished by their architecture (type of interconnection between the neurons, choice of activation functions, and other factors) and the learning method used.

The neural networks are not used only for prediction purposes. They are also used for classifying and/or clustering data with a view to reducing information. In practice, a neural network can, in a data set, identify common characteristics between the elements of that set, to then cluster them according to their resemblance. Each duly constituted cluster then has associated with it an element representative of the information contained in the cluster, called “representative”. This representative can then replace the whole of the cluster. The data set can thus be described by means of a small number of elements, which constitutes a data reduction. The Kohonen maps, or self-organizing maps (SOM), can be neural networks dedicated to this clustering task.

A question was raised concerning the choice of the directions of the HRTFs to be measured to conduct the step c) described above.

The method that seemed the most direct consisted in a uniform selection in which a subset of directions was chosen, seeking to cover as uniformly and evenly as possible, the whole of the 3D sphere. This method relied on a regular sampling of the 3D sphere. Now, it turns out that the HRTFs did not vary uniformly according to the direction. From this point of view, a uniform selection of the HRTFs was not truly effective.

A more promising method consisted in applying the abovementioned clustering technique in order to identify the most “relevant” directions of the HRTFS, that is, the best representatives of the characteristics of the HRTFs observed over the whole of the 3D sphere. When applied to the determination of the HRTFs of an individual, this clustering technique can consist:
in a first step, in identifying the redundancies between the HRTFs of adjacent directions,
in a second step, in clustering the HRTFs according to a resemblance criterion,
in a third step, the whole of the 3D sphere surrounding the listener is thus subdivided into a small number of areas that correspond to the various clusters of HRTFs identified previously, and
in a fourth step, each cluster has an HRTF associated with it which is considered as the representative of the cluster.

This “representative” HRTF is one of the HRTFs of the cluster and it is selected as the HRTF that minimizes a criterion of distance with all the other HRTFs of the cluster. The representative HRTF contains most of the information of the HRTFs of the cluster. Ultimately, the duly obtained set of representative HRTFs constitutes a compact description of the properties of the HRTFs for the whole of the 3D sphere.

This technique had given good results with respect to the model. The first result is a data reduction. The clustering procedure also provides additional information as the directions associated with the representative HRTFs, this information making it possible to define a selection of HRTFs intended to supply the input of the HRTF calculation model. This selection is a priori non-uniform, but more effective, and ensures a better “representativeness” of the whole of the 3D sphere.

Nevertheless, it became apparent to the inventors that this clustering step was not necessary and that, in fact, a few HRTF measurement directions could be chosen initially, arbitrarily without the model being falsified or its performance levels being in any way reduced. One considerable advantage is then that these directions can be chosen freely according to the preferred measurement conditions which will be described in detail later.

Thus, the present invention proposes the use, as model input parameters, of a selection of HRTFs corresponding to any directions in so far as these directions are not necessarily “representative” (in the sense of the clustering technique explained above). However, these directions remain usable in so far as the model is capable of extracting specific information relating to each individual.

Preferably, the invention uses statistical learning algorithms of the “artificial neural network” type, as the modeling tool for calculating the HRTFs (for example, with a “multilayer perceptron”, or MLP, type neural network). The input parameters of the neural network are at least the azimuth angle (θ1) and elevation angle (Φ1) specifying the direction of an HRTF to be calculated. These parameters are, if necessary, complemented with “individual” parameters associated with the individual for whom the HRTFs are to be calculated. These individual parameters comprise a selection of HRTFs of the individual that have been measured previously. Nevertheless, the addition of the morphological parameters of the individual as input for the model to add to the information to be supplied to the model is not precluded.

The output parameters of the model are then the coefficients of the vector describing the HRTF for the direction (θ1, Φ1) and for the individual specified as input.

Referring again to FIG. 1, the principle of the calculation of the HRTFs by the creation of an artificial neural network (for example of MLP type) comprises:
the input layer 10 consisting of the input parameters then including:
   the HRTFs already measured only for a few directions in space and denoted HRTF (Φᵢ^{mes}, θᵢ^{mes}) with i between 1 and n,
   the directions for which the HRTFs are to be calculated, preferably specified in the form of an elevation angle (Φⱼ^{cal}) and an azimuth angle (θⱼ^{cal}), with j between 1 and N, N being much greater than n,
the output layer 12 giving the HRTFs of the individual in the directions (Φⱼ^{cal}, θⱼ^{cal}) specified as input, and
one or more hidden layers 11 which will seek, by adjusting the weights and the activation functions of the neurons, to best model the relationships between the input layer and the output layer.

Now referring to FIG. 2, creating a neural network involves three steps:
the learning phase 21,
the validation phase 22, and
the test phase 23.

To complete these three phases successfully, there is initially a database 20 of HRTFs collected from one or more individuals. Thus, it will be understood that a preliminary step for collecting HRTF measurements for several individuals in all the directions in space is implemented. This is how the database 20 is constructed.

This database 20 is subdivided into three separate sets:
a learning set (APPR),
a validation set (VALID),
a test set (TEST).

For the learning phase 21, there are pairs combining:
an input vector X (describing the direction of the HRTF to be calculated and the individual parameters such as the measurement of the HRTFs in a few directions),
and an output vector Y (corresponding to the HRTF that the neural network must best estimate).

Learning entails, for each duly formed pair obtained from the learning set:
optimizing the neural network (in terms of the weights and the activation functions of the neurons),
and in comparing the result obtained by the neural network with the expected result (HRTF measured on the individual), so as to minimize a given error criterion.

One risk of the learning phase is overlearning which can be described as follows: the neural network learns “by heart” the learning set and seeks to reproduce variations specific to the learning set, although they do not exist globally. To avoid overlearning, the validation phase 22 is conducted in conjunction with the learning phase 21. Referring to FIG. 3, it consists in evaluating the prediction error of the neural network on a validation set (separate from the learning set), which defines the validation error. During the learning phase, the validation error Err_valid begins by decreasing, then starts to increase again when overlearning becomes manifest. The minimum MIN of the validation error therefore determines the end of the learning phase.

In fact, this observation directly affects the number of HRTFs measured to supply as input for the model, after the learning phase, that is, in the step c) described above. In practice, the smaller the number of measurements and the less information the model has to calculate the HRTFs, the greater the validation error. However, the more measurements there are, the greater the risk of overlearning becomes. It will therefore be remembered that an advantageous optional characteristic of the inventive method provides, in the learning step b), for determining an optimum number Nopt (FIG. 3) of measured HRTFs (Nb_HRTF^{mes}) to be supplied as input for the model to implement the step c).

The test phase is conducted once the learning phase is finished, and consists in evaluating the prediction error on the test set. This error, called “test error”, ultimately describes the ultimate performance characteristics of the neural network.

At the end of these three phases, there is an operational neural network, to which the input parameters simply have to be submitted to obtain the HRTFS of an individual in a direction.

Thus, with reference to FIG. 4a, the method in the general sense of the invention therefore comprises a step a) during which a database 20 is constructed by measuring a plurality of HRTFs in a multiplicity of directions in space for a plurality of individuals. This measurement step, referenced 40 in FIG. 4a, consists in collecting the measurements of HRTFs in N directions in space, for a number of individuals, preferably of different morphology (or “morphotype”), to obtain an exhaustive database according to the specifics of the individuals. More generally, the more individuals there are taken into account in the learning step, the better the performance characteristics of the neural network become, particularly in “universality” terms.

The next step b) consists in the learning of the model using the database 20. In the step 41, a small number n (with n<N) of measurements representative of HRTFs are chosen arbitrarily. This step 41 will be described in more detail later, with reference to FIG. 4c. The three phases—learning 21, validation 22 and test 23—are then carried out to construct the model in the step 44. It will be noted that it is possible to adjust the small number of measurements n to avoid the overlearning phenomenon described above. Thus, it is possible to determine an optimum number Nopt of measurements necessary for the correct operation of the model (step 42) and to adopt this optimum number (step 43) for the definition of the model. Ultimately, the neural network 44 for calculating the HRTFS is obtained. The neural network 44 is then capable of calculating the HRTFs of any individual, in any direction, provided that there are a few HRTFS of the individual in the predetermined directions Φᵢ^{mes}, θᵢ^{mes}.

Once the model is constructed (step 44), it is possible, during a subsequent step c), to determine the HRTFs of any individual in all directions in space. Thus, with reference to FIG. 4b:
c1) the HRTFs of the individual are measured in the measurement directions i (HRTF(Φᵢ^{mes}, θᵢ^{mes})) and the directions in which a calculation of HRTFs (Φⱼ^{cal}, θⱼ^{cal}) is required are indicated to the model, in a step 45,
c2) the model 44 is then applied to these HRTF measurements, and
c3) the HRTFs of the individual are obtained, calculated in the required directions Φⱼ^{cal}, θⱼ^{cal} (step 46).

However, it will be recalled that the measurement conditions of the step c1) must be substantially reproducible with the measurement conditions for HRTFs in the directions i (step 41 of FIG. 4a).

With reference to FIG. 4c, an optional aspect of the invention for a preferred embodiment of the model learning step is now specified. In practice, the database 20 must be constructed in the most conventional and the most standard conditions to offer, as model output, quality HRTFs that can be applied to playback devices offering satisfactory listening comfort. However, a second type of measurements is preferably carried out, parallel to the construction of the database 20, in conditions that can be different, even “degraded”, and in a small number of directions. The measurements of this second type are performed on the same individuals as those on whom the measurements constituting the database 20 were conducted. These “degraded” measurements are denoted HRTF(Φᵢ^{mes}, θᵢ^{mes}) and performed in a step 48 in FIG. 4c.

Then, during a step 49, the directions (Φⱼ^{cal}, θⱼ^{cal}) in which the HRTFs must be calculated by the model are specified as input for the model. Preferably, this will of course concern the greatest possible number of directions in the 3D space. One version of the model 44b, in the learning state, calculates the HRTFs in these directions (Φⱼ^{cal}, θⱼ^{cal}) based on series of “degraded” measurements HRTF(Φᵢ^{mes}, θᵢ^{mes}), in a subsequent step 46b. The model compares these calculated HRTFs with the HRTFs in the database 20 in the same directions (Φⱼ^{cal}, θⱼ^{cal}). If the deviation is deemed to be too great (arrow n), the model in the learning state 44b is refined until this deviation is reduced to an acceptable error (arrow o): the model then becomes definitive (end step 44).

It will therefore be remembered that, in the step a), parallel to the construction of the database 20 for a plurality of individuals, respective series of functions representative of the HRTFs (denoted HRTF(Φᵢ^{mes}, θᵢ^{mes})) are also measured, on this same plurality of individuals, in the arbitrarily fixed measurement conditions and directions. For the construction of the model in the step b):
these respective series of measurements HRTF(Φᵢ^{mes}, θᵢ^{mes}) are then applied as input for the model, and
the database 20 is applied to the output of the model for a comparison of the calculated HRTFs with those in the database.

Of course, this optional implementation of FIG. 4c is advantageous in particular if the measurements HRTF(Φᵢ^{mes}, θᵢ^{mes}) are really degraded relative to those used to construct the database 20. It will also be recalled that these measurement conditions HRTF(Φᵢ^{mes}, θᵢ^{mes}) must be substantially the same as those of the step c1) conducted on any individual.

With reference to FIG. 5, there now follows a description of one exemplary implementation of these measurement conditions. The individual IND is placed in a booth CAB which is not necessarily anechoic. He has a headset CAS having at least one microphone MIC attached to one of his ears. Preferably, the headset CAS is held by a rigid rod that is telescopic height-wise (along the y axis). This rod is, moreover, fixed to a reference point REP1 of the booth CAB. This implementation makes it possible to keep the individual IND immobile (relative to the other x and z axes) and to position him correctly relative to the reference point REP1 and, consequently, relative to the sound sources S1, S2, . . . , Sn of the booth CAB. Moreover, another reference point REP2, such as a visual reference point on a mirror, enables the individual to position himself height-wise (along the y axis). Typically, the individual can be seated on a height-adjustable seat and adjust this height until his ears coincide with the reference point REP2 on the mirror.

It will already be understood that one advantage of the implementation of the invention is to avoid the clustering technique and to allow a free choice when it comes to the placement of the sound sources S1-Sn. For example, it is possible to position these sources somewhere other than on the level of the mirror bearing the reference point REP2, or even somewhere other than the level of the base of the rod REP1. Typically, in the example of FIG. 5, the source S2 is slightly offset relative to the reference point REP1.

The number of sources S1-Sn to be provided depends, in principle, on the number of HRTFs that are to be calculated from the model. Typically, to calculate HRTFs in the entire 3D space, between 25 and 30 preliminary measurement directions in the booth CAB are recommended. Nevertheless, for satisfactory listening comfort, around 15 measurements are sufficient.

Finally, in absolute terms, a single measurement would be sufficient to obtain a single estimated HRTF. The measurement direction that is closest to the HRTF direction to be calculated will then be chosen.

More generally, it will be remembered that the optimum number of measurement directions, and therefore the number of measurements Nopt (FIG. 3), is around twenty.

It should also be stated that between 700 and 1000 measurement directions (for each ear) are normally necessary to obtain a good database of the HRTFS of an individual, according to the prior art technique. The reduction in the number of useful measurements, according to the invention, can then be appreciated.

It will also be observed, in FIG. 5, that the sources S1 to Sn are not necessarily positioned on one and the same sphere portion area. In practice, the aim of the measurement protocol of FIG. 5 is not to obtain HRTFS in the strict sense of the term, but, more precisely, transfer functions of an individual, these transfer functions being partially representative of his HRTFS. These transfer functions are intended for use as input parameters for the model 44. The inventors in fact observed that the model was capable of extracting and analyzing the individual information contained in these transfer functions, even if this information was partial or scrambled. What is important is not the quality of the HRTFs measured according to this protocol, but their reproducibility. It is mainly this reproducibility on which the model of HRTFs is based. One advantage offered by this measurement protocol is to relax the constraints of the measurement procedure, without in any way affecting the satisfactory operation of the model.

It will therefore be remembered that, in the installation as represented in FIG. 5, the sound sources S1-Sn provided in the booth CAB can be in respective positions belonging to separate sphere surfaces.

It will also be understood that the measurements applied as input for the model are not necessarily real HRTFS, but transfer functions representative of HRTFs. Moreover, these transfer functions presented at the input of the model can take various forms (corresponding to different representations of HRTFs), in particular:
a complex spectrum of the transfer function,
a modulus of the spectrum of the transfer function,
a phase of the spectrum of the transfer function,
an impulse response associated with the transfer function,
or a combination of these various elements.

It should also be stated that at least one additional parameter, which can be supplied as input for the model can be of morphological type and specific to the individual IND, such as the distance between his two ears. In this case, the learning, validation and test phases of the neural network are carried out based on a database comprising, in addition to the HRTFs, morphological parameters of the individuals, such as:
the distance between the ears, as stated above,
and/or a position and/or a shape of the auricles of the individual's ears,
and/or ellipsoid dimensions representing his head and/or his torso,
and/or the dimensions of a cylinder representing his neck.

Referring once again to FIG. 5, the signals measured by the microphone MIC are collected by an interface 51 of a central processing unit CPU (for example, an audio acquisition card), which converts them into digital data. This data, possibly complemented by a measurement of the morphological parameter(s) of the individual, is then processed by the model 44 according to the invention. The model 44 can be stored in the form of a computer program product in a memory of the central processing unit CPU. The HRTFS calculated for all the directions in space that the model gives can then be stored in memory 52 or saved on a removable medium (on diskette or etched on CD-ROM), or even communicated via a network such as the Internet or equivalent.

Thus, in this advantageous implementation, the input layer of the neural network comprises a selection of HRTFs of the individual corresponding to any directions, but a priori fixed, and obtained in non-ideal conditions. Although these “approximate” HRTFs are obtained by direct measurement on the individual IND, they are obtained in non-ideal conditions, notably in an environment that is not necessarily anechoic. However, the measurement protocol must be defined beforehand (typically in the learning step b)) and must be strictly followed in the step c) of application of the model to any individual. The neural network obtained in this way is capable of calculating the HRTFs of any individual, in any direction, subject to the availability of the measurements in the directions Φᵢ^{mes} and θᵢ^{mes} chosen and obtained in these predefined conditions.

Of course, the present invention is not limited to the embodiment described above by way of example; it can be extended to other variants.

For example, instead of providing a plurality of sound sources S1-Sn in the booth described with reference to FIG. 5, it is possible, as a variant, to provide a single source which is moved between positions S1 to Sn.

1. A method of calculating head-related transfer functions (HRTFs) specific to an individual, comprising:
a) constructing a database having a plurality of HRTFs in a multiplicity of directions in space and for a plurality of individuals;
b) by learning from said database, constructing a model corresponding to the HRTFs for said multiplicity of directions, wherein the model is based on a series of measurements representative of HRTFs in respective directions selected from said multiplicity of directions; and
c) for any individual:
c1) measuring a series of functions representative of the HRTFs of the individual only in said selected directions;
c2) applying the model to said measurements in the selected directions; and
c3) obtaining the HRTFs of the individual in all said multiplicity of directions,
and wherein:
the measurement conditions and directions to obtain said series of measurements are arbitrarily fixed during (b), and
measurement conditions roughly reproducible with the measurement conditions of the step (b) are applied in step (c).

2. The method as claimed in claim 1, wherein step (a) includes, parallel to constructing said database for said plurality of individuals, measuring respective sets of functions representative of the HRTFs, on said plurality of individuals, in said arbitrarily fixed measurement conditions and directions, and wherein the construction of the model in step (b) includes applying
said respective sets as input for the model, and applying
said database as output for the model.

3. The method as claimed in claim 1, wherein constructing the model comprises by setting up an artificial neural network.

4. The method as claimed in claim 3, wherein the step (b) comprises:
a learning phase;
a validation phase conducted in parallel with the learning phase; and
a test phase,
and wherein, during the validation phase, an optimum number of measurements to be supplied as input for the model is determined for implementation of the step (c), in order to limit an over-learning effect of the model.

5. The method as claimed in claim 4, wherein the optimum number is around twenty.

6. The method as claimed in claim 1, wherein the model also uses at least one morphological parameter characterizing an individual, and wherein, in the step (c2), a measurement of said morphological parameter is also supplied to the model.

7. The method as claimed in claim 1, wherein, in the step (c2), the model has supplied to it as input:
the series of measurements in said selected directions; and
at least one direction out of said multiplicity of directions in which an estimation of HRTFs is desired.

8. A system for estimating head-related transfer functions (HRTFs) specific to an individual, comprising:
a booth for measuring transfer functions representative of HRTFs in a set of chosen directions; and
a processing unit for recovering a series of measurements on an individual in said chosen directions and evaluating the HRTFs of the individual in a first plurality of directions in space including said chosen directions, based on a model capable of giving HRTFs for the multiplicity of directions, based on a series of measurements representative of HRTFs in a second plurality of arbitrarily fixed directions, wherein the second plurality is a subset of the first plurality,
and wherein the measurement directions in said booth correspond to said arbitrarily fixed directions.

9. The system as claimed in claim 8, wherein the sound sources, provided in said booth, are in respective positions belonging to separate sphere surfaces.

10. A computer program product, comprising instructions in computer code form to construct a model based on an artificial neural network and capable of calculating head-related transfer functions (HRTFs) of an individual for a first plurality of directions, based on a series of measurements, performed on said individual, representative of HRTFs, in a second plurality of arbitrarily fixed directions of said multiplicity of directions, wherein the second plurality is a subset of the first plurality, the program using a database including a plurality of HRTFs in a multiplicity of directions in space and for a plurality of individuals to implement at least one learning phase.

11. A computer program product, comprising instructions in computer code form for implementing a model based on an artificial neural network and capable of calculating head-related transfer functions (HRTFs) of an individual for a first plurality of directions, based on a series of measurements performed on said individual, representative of HRTFs, in a second plurality of arbitrarily fixed directions of said multiplicity of directions, wherein the second plurality is a subset of the first plurality.

12. A method of constructing a model intended to give head-related transfer functions (HRTFs) specific to an individual for a multiplicity of directions in space, comprising:
constructing a database including a plurality of HRTFs in a first plurality of directions in space and for a plurality of individuals; and
by learning from said database, constructing said model on the basis of a series of measurements representative of HRTFs in respective directions selected from said first plurality of directions in space.

13. The method according to claim 12, wherein HRTFs specific to an individual are given for said first plurality of directions in space, on the basis of a series of measurements representative of the HRTFs of the individual, and performed on said individual in a second plurality of selected directions and arbitrarily fixed among said first plurality of directions.
